(19) United States
(12) Patent Application Publication
(10) Pub. No.: US 2005/0117354 A1
(43) Pub. Date: Jun. 2, 2005

(54) Lamp shade

(76) Inventor: Kevin Hsu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/714,990

(22) Filed: Nov. 17, 2003

(51) Int. Cl. F21V 11/00; F21S 8/08

(52) U.S. Cl. 362/414

(57) ABSTRACT

A lamp shade includes a shade having a first end and a second end, an upper ring detachably mounted on the first end of the shade, and a lower ring detachably mounted on the second end of the shade. Thus, the lamp shade can be folded when not in use, so as to reduce the volume of the lamp shade, thereby facilitating package, storage and transportation of the lamp shade, and thereby decreasing the costs of package and transportation.

### BACKGROUND OF THE INVENTION

1. Field of the Invention

The present invention relates to a lamp shade, and more particularly to a lamp shade that can be folded when not in use, so as to reduce the volume of the lamp shade, thereby facilitating package, storage and transportation of the lamp shade, and thereby decreasing the costs of transportation.

2. Description of the Related Art

A conventional lamp shade 1 in accordance with the prior art shown in FIG. 6 comprises an upper ring 11, a lower ring 12, and a plurality of ribs 13 mounted between the upper ring 11 and the lower ring 12. The upper ring 11 has a mounting rack 111 for mounting a lamp, such as a table lamp.

However, the ribs 13 are fixed between the upper ring 11 and the lower ring 12 by soldering, so that the conventional lamp shade 1 has a fixed volume and cannot be folded, thereby causing inconvenience in package, storage and transportation of the conventional lamp shade 1, and thereby increasing costs of package and transportation.

### SUMMARY OF THE INVENTION

The primary objective of the present invention is to provide a lamp shade that can be folded when not in use, so as to reduce the volume of the lamp shade, thereby facilitating package, storage and transportation of the lamp shade, and thereby decreasing the costs of package and transportation.

Another objective of the present invention is to provide a lamp shade that can be assembled and disassembled easily and conveniently, thereby facilitating the user assembling and disassembling the lamp shade.

In accordance with the present invention, there is provided a lamp shade, comprising:
a shade having a first end and a second end;
an upper ring detachably mounted on the first end of the shade; and
a lower ring detachably mounted on the second end of the shade.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a lamp, shade in accordance with the preferred embodiment of the present invention;

FIG. 2 is a folded view of a shade of the lamp shade as shown in FIG. 1;

FIG. 3 is a partially perspective assembly view of the lamp shade as shown in FIG. 1;

FIG. 4 is a plan cross-sectional view of the lamp shade as shown in FIG. 3;

FIG. 5 is a schematic plan assembly view showing the lamp shade being mounted on a table lamp; and

FIG. 6 is a perspective view of a conventional lamp shade in accordance with the prior art.

### DETAILED DESCRIPTION OF THE INVENTION

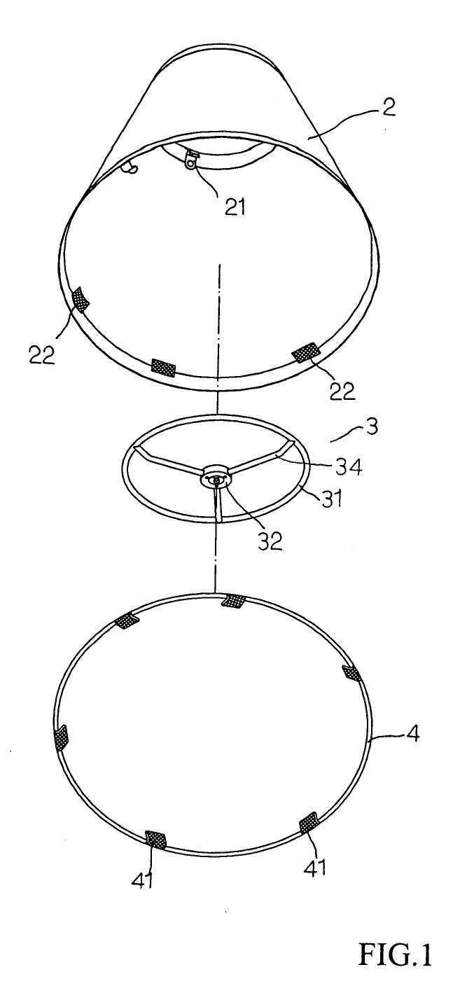

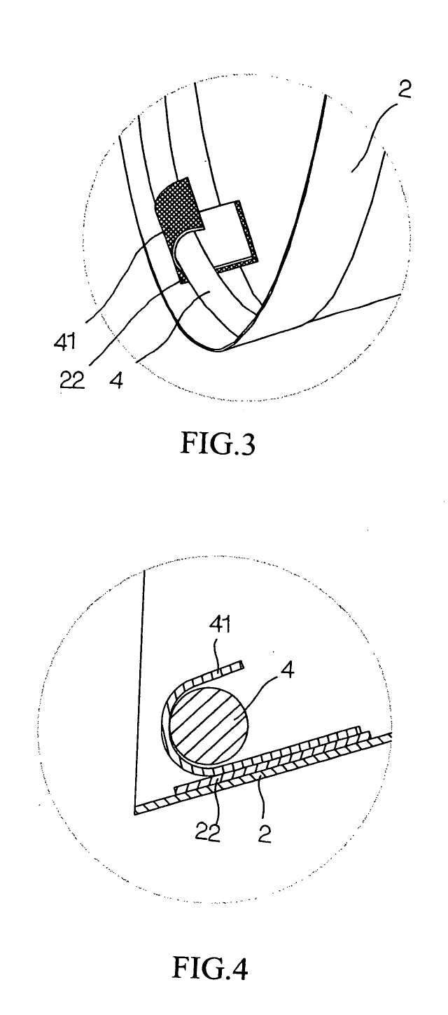

Referring to the drawings and initially to FIGS. 1-4, a lamp shade in accordance with the preferred embodiment of the present invention comprises a shade 2, an upper ring 3, and a lower ring 4.

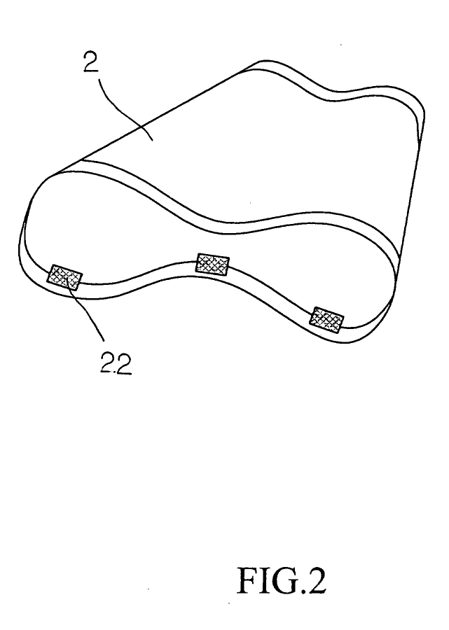

The shade 2 is made of flexible material, such as cloth or the like, so that the shade 2 is foldable as shown in FIG. 2. The shade 2 has a first end provided with a plurality of elastic locking plates 21 and a second end provided with a plurality of bonding straps 22. Preferably, each of the bonding straps 22 of the shade 2 is a loop-shaped or hook-shaped strap.

The upper ring 3 is detachably mounted on the first end of the shade 2 and has a rim 31 locked by the elastic locking plates 21 of the shade 2, and a central portion formed with support portion 32 supported by a plurality of spiders 34.

The lower ring 4 is detachably mounted on the second end of the shade 2 and is provided with a plurality of bonding straps 41 each engaged with a respective one of the bonding straps 22 of the shade 2, so that the lower ring 4 is detachably mounted on the second end of the shade 2. Preferably, each of the bonding straps 41 of the lower ring 4 is a loop-shaped or hook-shaped strap.

In assembly, referring to FIGS. 1-5, the upper ring 3 is mounted on the first end of the shade 2 with its rim 31 being locked by the elastic locking plates 21 of the shade 2. Then, the lower ring 4 is mounted on the second end of the shade 2 and each of the bonding straps 41 of the lower ring 4 is engaged with a respective one of the bonding straps 22 of the shade 2, so that the lower ring 4 is detachably mounted on the second end of the shade 2. Thus, the upper ring 3 is mounted on the first end of the shade 2 and the lower ring 4 is mounted on the second end of the shade 2, thereby forming the expanded lamp shade.

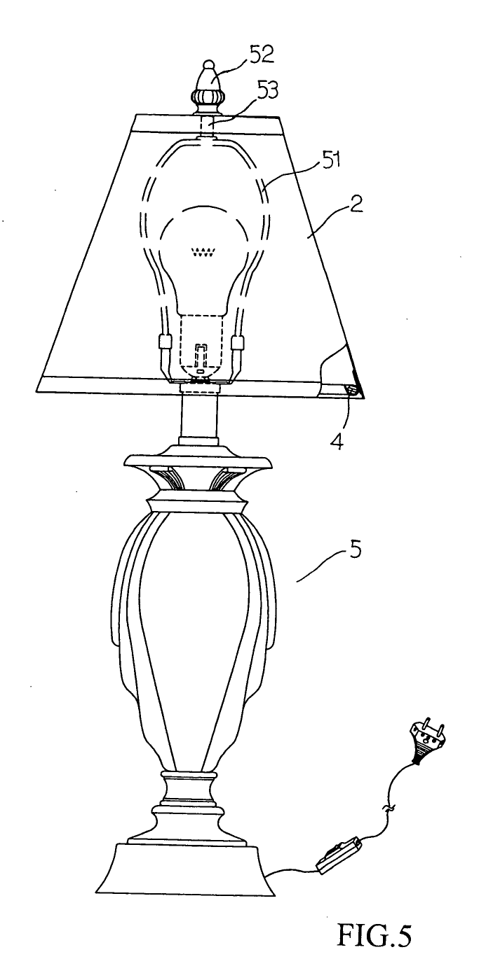

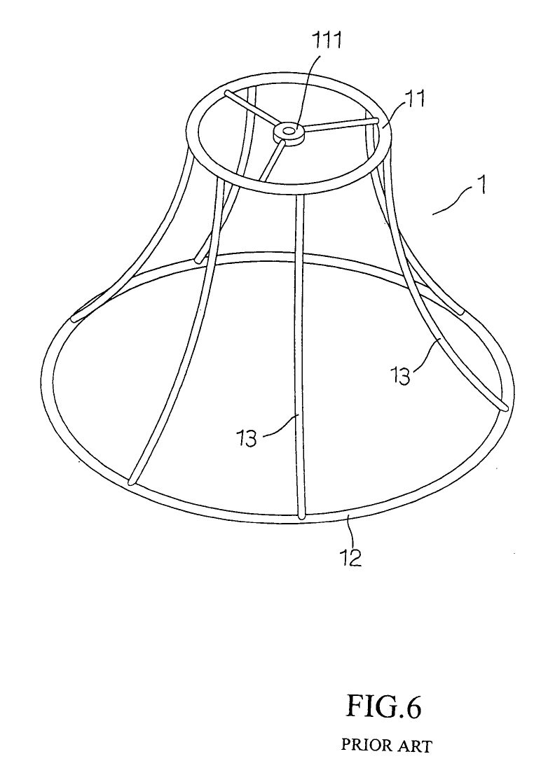

As shown in FIGS. 1 and 5, the expanded lamp shade is mounted on a table lamp 5. The table lamp 5 includes a harp 51 mounted in the shade 2 and rested on the bottom of the support portion 32 of the upper ring 3, a threaded rod 53 mounted on the harp 51 and extended through the support portion 32 of the upper ring 3, and a decorative nut 52 screwed on the threaded rod 53 and rested on the top of the support portion 32 of the upper ring 3, so that the expanded lamp shade is mounted on the table lamp 5.

Alternatively, the decorative nut 52 is unscrewed from the threaded rod 53 to detach the support portion 32 of the upper ring 3 from the threaded rod 53 of the harp 51, so that the expanded lamp shade can be removed from the table lamp 5. Then, the lower ring 4 is detached from the second end of the shade 2, and the upper ring 3 is detached from the first end of the shade 2, so that the shade 2 is folded as shown in FIG. 2.

Accordingly, the lamp shade is assembled and disassembled easily and conveniently, thereby facilitating the user assembling and disassembling the lamp shade. In addition, the lamp shade can be folded when not in use, so as to reduce the volume of the lamp shade, thereby facilitating package, storage and transportation of the lamp shade, and thereby decreasing costs of package and transportation.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A lamp shade, comprising:
a shade having a first end and a second end;
an upper ring detachably mounted on the first end of the shade; and
a lower ring detachably mounted on the second end of the shade.

2. The lamp shade in accordance with claim 1, wherein the shade is made of flexible material.

3. The lamp shade in accordance with claim 2, wherein the shade is made of cloth.

4. The lamp shade in accordance with claim 1, wherein the shade is foldable.

5. The lamp shade in accordance with claim 1, wherein the first end of the shade is provided with a plurality of elastic locking plates, and the upper ring has a rim locked by the elastic locking plates of the shade.

6. The lamp shade in accordance with claim 1, wherein the second end of the shade is provided with a plurality of bonding straps, and the lower ring is provided with a plurality of bonding straps each engaged with a respective one of the bonding straps of the shade, so that the lower ring is mounted on the second end of the shade.

7. The lamp shade in accordance with claim 6, wherein the each of the bonding straps of the shade is a loop-shaped strap, and each of the bonding straps of the lower ring is a hook-shaped strap.

8. The lamp shade in accordance with claim, 6, wherein the each of the bonding straps of the shade is a hook-shaped strap, and each of the bonding straps of the lower ring is a loop-shaped strap.
